(19) United States
(12) Patent Application Publication
(10) Pub. No.: US 2025/0371769 A1
(43) Pub. Date: Dec. 4, 2025

(54) SYSTEMS AND METHODS FOR VISUALIZATION OF A BUILT ENVIRONMENT

(71) Applicant: Leap Tools Inc., Toronto (CA)

(72) Inventor: Vlad Cristian SUSANU, Toronto (CA)

(21) Appl. No.: 19/228,602

(22) Filed: Jun. 4, 2025

Related U.S. Application Data
(60) Provisional application No. 63/655,725, filed on Jun. 4, 2024.

(51) Int. Cl. G06T 11/60; G06F 3/0482; G06F 3/04845; G06T 7/12

(52) U.S. Cl. CPC G06T 11/60; G06F 3/0482; G06F 3/04845; G06T 7/12

(57) ABSTRACT

Systems and methods are disclosed for generating an image of a built environment using a visualization application and an application system. The application system can obtain from the visualization application an indication of an original image and of a style. The application system can detect a characteristic of the original image and enrich a style conditioning prompt based on the detected characteristic. The application system can obtain a transformed image generated using the original image and the style conditioning prompt. The application system can provide the transformed image or an annotated version of the transformed image to the visualization application for display. The application system can receive from the visualization application instructions to generate an updated version of the transformed image. The instructions can include selection of a segment of the transformed image. The application system can generate and provide to the visualization application for display an updated transformed image.

### RELATED APPLICATIONS

This application claims the benefit of priority to U.S. Provisional Patent Application No. 63/655,725, filed Jun. 4, 2024, which is incorporated herein by reference in its entirety.

### BACKGROUND

A generative artificial intelligence model can be trained and configured to transform an original image into another transformed image. A prompt can be used to constrain or condition this transformation. As may be appreciated, a suitable generative artificial intelligence model can generate such a transformed image. However, a user may wish to make further modifications to discrete portions of the image. Conventional generative artificial intelligence pipelines often struggle with providing users the ability to control fine details of an output image. Furthermore, a user may wish to make multiple changes to the transformed image, or revert some but not all changes. Such interactions may be difficult or impossible with a conventional generative artificial intelligence pipeline.

### SUMMARY

The disclosed systems and methods can enable the transformation of an original image as a whole in accordance with a stylistic prompt, and then the controlled-segment level refinement of that transformed image. Furthermore, these refinements can be based on existing, real-world objects, improving the ability of the user to implement hypothetical transformations in the real world.

The disclosed embodiments include a system. The system can include at least one processor; and at least one non-transitory computer readable medium containing instructions. When executed by the at least one processor, the instructions can cause the system to perform operations for generating an image of a built environment. The operations can include providing, to a visualization application running on a client system, instructions to display in a first graphical user interface including a style control and a product control, an original image of the built environment. The operations can further include receiving, from the visualization application, a selection of the original image and a selection of the style control. The operations can further include detecting a characteristic of the original image and enriching a style conditioning prompt based on the detected characteristic. The operations can further include obtaining a transformed image generated by applying the original image and the style conditioning prompt to a generative artificial intelligence model. The operations can further include identifying a segment in the transformed image associated with an architectural feature in the transformed image using at least one machine-learning model. The operations can further include providing, to the visualization application, instructions to display in the first graphical user interface the transformed image and a selectable graphical indicator of the identified segment. The operations can further include receiving, from the visualization application, a selection of the product control and a selection of the selectable graphical indicator. The operations can further include generating an updated transformed image that replaces the segment in the transformed image based on the selection of the product control and the selection of the selectable graphical indicator. The operations can further include providing, to the visualization application, instructions to display in the first graphical user interface the updated transformed image.

In some embodiments, the style conditioning prompt can include a textual prompt, the detected characteristic can include a room type, and enriching the style conditioning prompt can include modifying a textual prompt to indicate the room type. In some embodiments, the style conditioning prompt can include a textual, image, or auditory prompt. In some embodiments, the architectural feature can be a wall, floor, counter, staircase, ceiling, window, balcony, doorway, or door. In some embodiments, identifying the segment in the transformed image can include performing semantic segmentation of the transformed image or performing object detection in the transformed image.

The disclosed embodiments include a method for generating an image of a built environment. The method can include obtaining, by an application system, an original image of the built environment and an enriched style conditioning prompt concerning a style of the built environment. The method can further include generating a transformed image by applying the original image and the enriched style conditioning prompt to a generative machine learning model. The method can further include identifying, by the application system, a segment in the transformed image associated with an architectural feature in the transformed image using at least one machine learning model. The method can further include generating, by the application system, an updated transformed image by replacing the segment in the transformed image. The method can further include displaying, by a client system, the updated transformed image.

In some embodiments, the method can further include detecting a characteristic of the built environment using the original image, and, prior to generating the transformed image, generating the enriched style conditioning prompt using the detected characteristic of the built environment. In some embodiments, the detected characteristic can include a room type, and generating the enriched style conditioning prompt can include modifying a textual prompt to indicate the room type. In some embodiments, the enriched style conditioning prompt can further be generated using a textual, image, or auditory prompt. In some embodiments, the architectural feature can be a wall, floor, counter, staircase, ceiling, window, balcony, doorway, or door. In some embodiments, identifying the segment in the transformed image can include performing semantic segmentation of the transformed image or object detection in the transformed image. In some embodiments, the application system can receive the original image from a visualization application running on the client system. In some embodiments, replacing the segment in the transformed image can include depicting a user-selected product in the segment.

The disclosed embodiments include another system. The system can include at least one processor and at least one non-transitory computer readable medium containing instructions. When executed by the at least one processor, the instructions can cause the system to perform operations for generating an image of a built environment. The operations can include obtaining an original image of the built environment and an enriched style conditioning prompt concerning a style of the built environment. The operations can include generating a transformed image by applying the original image and the enriched style conditioning prompt to a generative machine learning model. The operations can include identifying a segment in the transformed image associated with an architectural feature in the transformed image using at least one machine learning model. The operations can include generating an updated transformed image by replacing the segment in the transformed image. The operations can include providing the updated transformed image for display on a client system.

In some embodiments, operations can further include detecting a characteristic of the built environment using the original image, and, prior to generating the transformed image, generating the enriched style conditioning prompt using the detected characteristic of the built environment. In some embodiments, the detected characteristic can include a room type, and generating the enriched style conditioning prompt can include modifying a textual prompt to indicate the room type. In some embodiments, the enriched style conditioning prompt can further be generated using a textual, image, or auditory prompt. In some embodiments, the architectural feature can be a wall, floor, counter, staircase, ceiling, window, balcony, doorway, or door. In some embodiments, identifying the segment in the transformed image can include performing semantic segmentation of the transformed image or object detection in the transformed image. In some embodiments, the original image can be received from a visualization application running on the client system.

The foregoing general description and the following detailed description are exemplary and explanatory only and are not restrictive of the claims.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 depicts an exemplary system for providing interactive visualizations using a single-page application, in accordance with disclosed embodiments.

FIG. 2 depicts a method for initializing a visualization application, in accordance with disclosed embodiments.

FIG. 3 depicts a method for generating an updated, transformed image, in accordance with disclosed embodiments.

FIG. 4 depicts a method for interacting with a visualization application to generate an updated, transformed image, in accordance with disclosed embodiments.

FIGS. 5 to 8 depict views of an exemplary graphical user interface for use with the methods of FIG. 3 or 4, in accordance with disclosed embodiments.

FIGS. 9A to 9C depict an original image, a style conditioning prompt image, and a transformed image generated in accordance with the methods of FIG. 3 or 4, and in accordance with disclosed embodiments.

FIG. 10 depicts a schematic of exemplary computing system for performing the envisioned systems and methods, in accordance with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting. It is to be understood in the ensuing description that reference to providing visualization of a product refers to providing visualization of an image of the product. The image may be a two-dimensional or a three-dimensional image.

The disclosed embodiments can provide an improved pipeline for image generation and modification. This improved pipeline can be applied to visualizing built environments, such as interior rooms or exterior portions of buildings or structures. A user can interact with this improved image generation and modification pipeline to generate a transformed image of such a built environment in a particular style (or in multiple styles) from an original image of the built environment. The user can then refine these transformed versions in a specific, controlled manner, enabling them to test specific modifications to the built environment in the context of the overall stylistic transformation.

As appreciated by the inventors, the characteristics of a built environment (e.g., a correspondence between room type, room contents, and room arrangements) enable a feedback process in which characteristics of the original image can be extracted and used to enrich a stylistic conditioning prompt, improving the accuracy and relevance of the transformed image. For example, architectural features (e.g., walls, floors, counters, stairs, staircases, ceilings, windows, balconies, doorways, doors, or the like), furnishings (e.g., wallpaper, curtains, fixtures, or the like), objects (furniture, appliances, decorations, decor items, equipment, tools, recreational equipment, or the like) or the like can be detected in the original image. The stylistic conditioning prompt can be enriched to preserve or favor preservation of the detected architectural features, furnishings, or objects. In this manner, the transformed image can reflect the architectural features, furnishings, or objects in the original image, while still displaying an updated style. Furthermore, characteristics of the built environment can support more precise segmentation and modification of the transformed image. Accordingly, the disclosed embodiments can provide users a powerful system for generating controlled, adaptable, and refined images of how a built environment can be transformed.

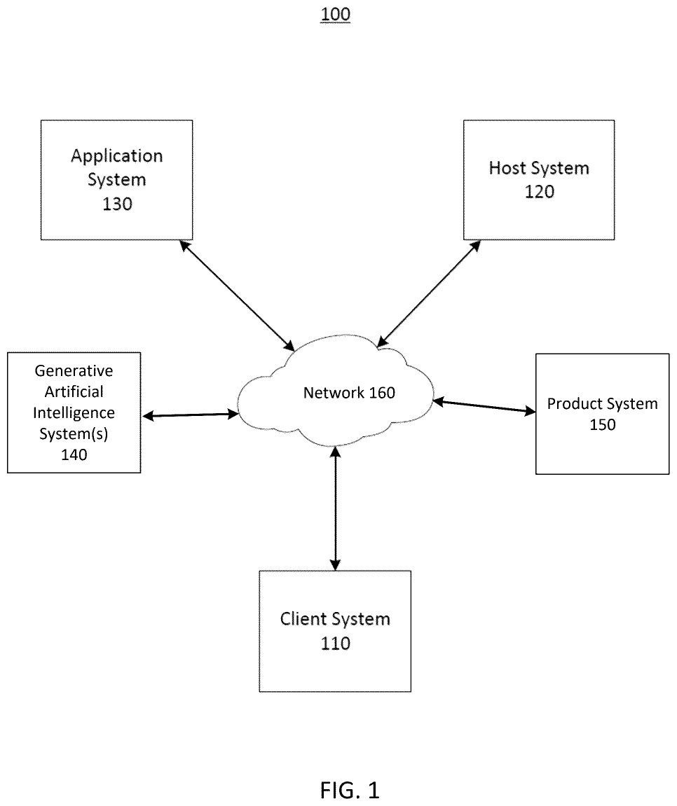

FIG. 1 depicts an exemplary system 100 for providing interactive visualizations using a single-page application, in accordance with the disclosed embodiments. As depicted in FIG. 1, system 100 can include client system 110, host system 120, application system 130, generative artificial intelligence system(s) 140, and product system 150. Client system 110, host system 120, application system 130, generative artificial intelligence system(s) 140, and product system 150 can be configured to communicate using network 160.

Client system 110 can be configured to retrieve the webpage from host system 120 and retrieve the script and visualization application from application system 130, in some embodiments. The script can be used to integrate the webpage and the visualization application, removing from the developer of the webpage the burden of integrating the webpage and visualization application. The script can configure the web browser displaying the webpage to perform a variety of useful functions. Such functions can include determining whether the browser can support the visualization application; determining whether products described or referenced in the product page are available for visualization; determining an appropriate language for providing the visualization; filtering out bots and crawlers that might otherwise pollute usage statistics; placing first-party cookies that can be used to track user sessions, as well as conversions (e.g., purchases or the like); and integrating the visualization application with an ordering application, so that users can initiate orders from within the visualization application. As described herein, the script can be embedded into the webpage using a tag. Thus the functionality provided by the disclosed embodiments can be added to a webpage without requiring extensive modifications to the webpage.

Integration of the visualization application into the webpage can be handled using the script, which can be customized for the webpage. Furthermore, the visualization application can be configured to run independently of the webpage, such that user manipulation of an image displayed in the visualization application may occur without requiring reloading of the webpage. The visualization application can modify a webpage (which need not originally support single-page application functionality) to provide single-page application functionality. In some embodiments, client system 110 can be configured by the script to modify the webpage to include a container, such as an iframe, or the like. Client system 110 can then load the retrieved visualization application into the container. The disclosed embodiments are not limited to use of a container. Other modifications resulting in display of the visualization application are also envisioned, including addition of a layer over the existing webpage, opening a new tab or a new window to display the visualization application, or removing or rearranging one or more webpage elements to create space for displaying the visualization application. In this manner, the visualization application can be integrated into the webpage to provide the interactive visualizations. The visualization application can allow the user to transform an image based on a style reference and optionally further modify the transformed image to display images of products. The products can be products depicted or referenced in the webpage.

In some embodiments, the visualization application can obtain one or more resource identifiers specified by a webpage (e.g., a URL or the like). For example, the visualization application can receive a selection of a resource identifier from a user interacting with the webpage. As an additional example, the visualization application can parse the webpage (or a portion thereof) to identify one or more resource identifiers (e.g., URLs, or the like).

In some embodiments, the visualization application can provide the one or more resource identifiers to an application system. The application system can determine whether each resource identifier specifies an image, or specifies a suitable image (e.g., an image depicting a built environment, an interior of a built environment, an interior of a suitable room type of a built environment, or the like). In some embodiments, the webpage can include a number of images. The application system can provide a resource identifier for each image to the application system. The application system may obtain the images using the resource identifiers (e.g., retrieve them using provided URLs, or another suitable method), analyze each image, and determine whether the image can be restyled as described herein. In some embodiments, should the application system determine that an image can be restyled, the application system can enable the user to select the image for restyling. For example, the application system can provide instructions to the client system or visualization system to modify the webpage to include, display, unhide, or otherwise enable a control for triggering the restyling of the image.

In some embodiments, as may be appreciated, the determination of whether an image is suitable and the determination that an image can be restyle can be performed by the visualization application.

FIG. 1 depicts an exemplary system 100 for providing interactive visualizations using a single-page application, in accordance with the disclosed embodiments. As depicted in FIG. 1, system 100 can include client system 110, host system 120, and application system 130. Client system 110, host system 120, and application system 130 can be configured to communicate using network 160. Client system 110 can be configured to retrieve the webpage from host system 120 and retrieve the script and visualization application from application system 130. The script can be used to integrate the webpage and the visualization application, removing from the developer of the webpage the burden of integrating the webpage and visualization application. The visualization application can allow the user to modify an image to display products, and more specifically images of products. Such products can include, but are not necessarily limited to, products depicted or referenced in the webpage.

Client system 110 can be configured to display a webpage including a visualization of a built environment, in some embodiments. The visualization of the built environment can depict one or more interior rooms or spaces within a building or structure, or a portion of the exterior of the building or structure. The built environment is not limited to a particular type or use building or structure. For example, the built environment can be a home, or other residential building, a store, or other commercial building, a factory, or other industrial building, a hospital or school, or other governmental building, or the like. As may be appreciated, the disclosed embodiments can use an association between a detectable type or characteristic of the built environment and the contents, arrangement, or layout of the built environment to enrich a stylistic conditioning prompt, thereby improving a stylistic transformation of the visualization of the built-environment.

Client system 110 can be or include an interactive computing device with a display. For example, client system 110 can be or include a desktop, a laptop, smart phone, a tablet, or a wearable device. As an additional example client system 110 can be a special-purpose system, such an interactive kiosk with a display screen. Client system 110 can be configured to obtain the webpage from host system 120. For example, client system 110 can be configured with a web browser and a user of client system 110 can interact with the web browser (e.g., by entering a URL into an address bar or selecting a reference to the webpage in another webpage, or the like) to cause client system 110 to request a webpage from host system 120. In some embodiments, client system 110 can use the webpage to implement a single-page application, in which the webpage is repeatedly modified (e.g., in response to user interactions or data or instructions received from host system 120 or application system 130). In some embodiments, the webpage can include instructions that, when processed by client system 110, cause client system 110 to obtain a script from application system 130. Client system 110 can be configured to execute the script.

Client system 110 can be configured, according to the script, to determine whether the webpage can be modified to display a transformed image, annotated transformed image, or updated transformed image, as described herein. In some embodiments, client system 110 can determine candidate products for depiction in the updated transformed image. Such candidate products can include products displayed or referenced in the webpage. In various embodiments, client system 110 can determine whether application system 130 can obtain visualization information enabling generation of the updated transformed image. Such visualization information can include a model of a candidate product, a type of the selected product, or the like. The model of the candidate product can include spatial information and/or surface detail information. When provided, spatial information can specify the dimensions of the candidate product. In some embodiments, such spatial information can include a mathematical representation of one or more surfaces of the candidate product. In various embodiments, the spatial information can comprise a 2D or 3D model of the candidate product. For example, a 3D model of a lamp can specify the location of points on the surface of the lamp in a three-dimensional space. As a further example, a 2D model of a poster can specify the height and width of the poster. When provided, surface detail information can include textures, colors, patterns, or the like. For example, a product can be associated with a texture mapping, which can be applied to a 2D or 3D model of the product, or to a surface in the 3D model of the image. In various embodiments, some candidate products may not be associated with a spatial model. For example, in some embodiments, candidate products lacking predetermined dimensions, such as flooring, molding, paneling, wallpaper, countertops, or the like, may be associated with surface detail information but not spatial information. When such visualization information is available, client system 110 can be configured to modify the webpage to display a control.

Client system 110 can be configured, according to the script and in response to selection of the control, to modify the webpage to display a visualization application. Client system 110 can use the visualization application, in accordance with the script, to display the transformed image, annotated transformed image, or updated transformed image, consistent with disclosed embodiments. The visualization application can enable a user of client system 110 to select the image (e.g., by uploading the image, selecting a saved or predetermined image, or selecting from a number of images displayed on the webpage). The visualization application can enable a user of client system 110 to generate a style conditioning prompt. The user can interact with the client to generate the style conditioning prompt by entering text (or recording audio), selecting a non-image control (e.g., a textual control, a radio button, a toggle, or another suitable non-image control), selecting an image (e.g., by uploading a style image or selecting a saved or predetermined style image), or in another suitable manner.

Client system 110 can be configured to transmit a request to generate a transformed image to application system 130. Client system 110 can receive for display by client system 110 the transformed image (or an annotated transformed image) from application system 130. Client system 110 can be configured to transmit a request to display a product in the transformed image (or annotated transformed image) to application system 130. In some embodiments, the request can specify the product. In some embodiments, the request can specify a location in the transformed image (or a segment or location in the annotated transformed image). In response, client system 110 can receive instructions from application system 130 for displaying the product in the specified location of the transformed image (or specified segment or location in the annotated transformed image). In some embodiments, the instructions can include a version of the transformed image or annotated transformed image, modified to display the product (e.g., an updated transformed image). In various embodiments, the instructions can include a model of the product and instructions or data enabling the visualization application to display the model of the product in the transformed image or annotated transformed image (e.g., thereby forming the updated transformed image). For example, the instructions and data can specify at least one of a scaling, perspective, or lighting of the product in the image. Client system 110 can then display the updated transformed image in accordance with the instructions received from application system 130. For example, when the instructions include a model of the product and information describing the scale and perspective of the object at a location in the image, client system 110 can be configured to place an image of the product, based on the model, scale, and perspective information, at the location in the transformed image. In some embodiments, client system 110 can be configured to subsequently update the transformed image based on user interaction. For example, a user can interact with the visualization application to change the position or orientation of the product within the transformed image. For example, a user can interact with a user interface using a mouse or touchscreen to translate the product in the x and y direction of the image (e.g., using a one-finger gesture, or a mouse movement and first mouse button selection, or another suitable method), rotate the product (e.g., using a two-finger gesture, a mouse movement and an alternate mouse button selection, or another suitable method). In some embodiments, the depth of the product can be determined based on the estimated depth of the image at that x and y location in the image. The client can then recalculate how the model of the product is displayed, based on the changed position or orientation information and the instructions previously received from application system 130.

In some embodiments, the script can be configured to manage interactions or control communications between the visualization application and the webpage. For example, the visualization application can create events in response to user interactions. These events can be handled by the script. For example, the user can interact with the visualization application to indicate an intention to purchase a product. In response, the visualization application can generate an event, which can be handled by the script. The script can configure client system 110, in response to the event, to initiate a purchase or add the product to a shopping cart through the webpage. Similarly, the script can configure client system 110 to set cookies in response to events generated by the visualization application. These cookies can then be read by host system 120.

Host system 120 can be configured to provide the webpage to client system 110. Host system 120 can be or include a computing system, such as a desktop, workstation, server, server cluster, cloud computing environment (e.g., Amazon Web Services™ (AWS), Microsoft Azure™, IBM Cloud™, Google Cloud Platform™, Cisco Metapod™, Joyent™, vmWare™, or the like), or other suitable computing system. Host system 120 can be configured as a web server. For example, host system 120 can provide a webpage to a web browser in response to a request (e.g., HTTP requests or the like). The webpage can be configured to provide single-page application functionality. For example, the webpage can include data and instructions enabling a web browser of a client to modify the webpage without reloading a new webpage from host system 120.

In some embodiments, host system 120 can be associated with a provider of the products displayed or referenced by the webpage. For example, the host system can provide a catalog of the products available for purchase from the provider (e.g., host system 120 can provide a webpage for a consumer goods store such as Home Depot, Walmart, or the like). In some embodiments, host system 120 can be associated with a provider of the original image selected by the user (e.g., a real-estate listing company such as Zillow, or Redfin). In such embodiments, the product can be associated with product system 150 (which in turn can be associated with a consumer goods store such as Home Depot, Walmart, or the like).

Application system 130 can be configured to enable client system 110 to generate an updated transformed image. Application system 130 can be or include a computing system, such as a desktop, workstation, server, server cluster, cloud computing environment (e.g., Amazon Web Services™ (AWS), Microsoft Azure™, IBM Cloud™, Google Cloud Platform™, Cisco Metapod™, Joyent™, vmWare™, or the like), or other suitable computing system.

Application system 130 can be configured to provide a script to client system 110. Application system 130 can provide the script in response to a request transmitted by client system 110. As shown in the following example, the webpage can include an element that causes client system 110 to request the script from application system 130:

<script type=“text/javascript” src=“https://host address/scriptname” async></script>

In this example, the script tag can be included within the webpage (e.g., within a <head> tag or <body> of the webpage). The host address can be a URL pointing to a location hosted by application system 130 (e.g., a directory), while scriptname can be a name of the script stored by application system 130 at that location. In this example, the scriptname can be or include a codename associated with host system 120 or a product provider associated with host system 120. In this example, the location hosted by application system 130 can include multiple differing scripts having different script names. When client system 110 processes the webpage, the script tag can cause client system 110 to request the script scriptname located at host address from application system 130. Client system 110 can then execute the script to provide functionality as described herein.

Application system 130 can be configured to communicate with client system 110 after provision of the script. In some embodiments, application system 130 can communicate with client system 110 to obtain an original image and style conditioning prompt. In some embodiments, the original image can be received from another system (e.g., client system 110 or host system 120). For example, a user can interact with client system 110 to upload an original image to application system 130. In some embodiments, application system 130 can receive a selection of the original image from another system. For example, a user can interact with client system 110 to select an image (e.g., by selecting a control on the website that corresponds to the image). Application system 130 can receive an indication of the selected original image from client system 110 (or host system 120). In some embodiments, the style conditioning prompt can be received from another system (e.g., client system 110 or host system 120). For example, a user can interact with client system 110 to upload a style conditioning prompt in a modality (e.g., an image or video modality, a textual modality, an audio modality, or another suitable modality). In some embodiments, application system 130 can receive a selection of the style conditioning prompt from another system. For example, a user can interact with client system 110 to select a style conditioning prompt (e.g., by selecting a control on the website that corresponds to the style conditioning prompt). Application system 130 can receive an indication of the selected style conditioning prompt from client system 110 (or host system 120).

Consistent with disclosed embodiments, application system 130 can interface with Generative Artificial Intelligence System(s) 140 to generate a transformed image from an original image and a style conditioning prompt. In some embodiments, application system 130 can provide the original image and the style conditioning prompt to Generative Artificial Intelligence System(s) 140.

Consistent with disclosed embodiments, application system 130 can be configured to detect a characteristic of the original image. For example, application system 130 can detect architectural features, furnishings, or objects in the original image. Such detection can be performed using image classification software, such as GOOGLE CLOUD VISION, AMAZON REKOGNITION, MICROSOFT AZURE COMPUTER VISION, or other suitable image classification software. Application system 130 can then enrich the style conditioning prompt based on the detected characteristic of the original image. For example, the stylistic conditioning prompt can be enriched to preserve or favor preservation of the detected architectural features, furnishings, or objects. When the style conditioning prompt comprises a textual prompt, application system 130 can modify the textual prompt to identify the detected characteristic or add additional instructions or remove instructions based on predetermined matching rules and the detected characteristic. For example, application system 130 can include a textual description of the nature, size, location, orientation, or other details of detected architectural features, furnishings, or objects in the original image. In additional, application system 130 can include instructions to preserve the detected architectural features, furnishings, or objects in the original image (or aspects of these detected architectural features, furnishings, or objects, such as size, location, orientation, or the like).

Consistent with disclosed embodiments, application system 130 can receive a transformed image from generative artificial intelligence system(s) 140. The transformed image can be the result of applying the original image and the style conditioning prompt to one or more generative artificial intelligence models. As may be appreciated, the transformed image can include furnishings, architectural features, or the like that are absent from the original image or in different locations than corresponding furnishings, architectural features, or the like in the original image.

Application system 130 can be configured to generate an annotated transformed image using the transformed image. Generating the annotated transformed image can include processing the transformed image to determine image characteristics such as a perspective of the transformed image, to identify architectural features, furnishings, or objects in the transformed image, to determine distances to surfaces in the transformed image, or to obtain similar information. In some embodiments, identifying architectural features, furnishings, or objects in the transformed image can include identifying surfaces in the transformed image (e.g., floors, walls, countertops, ceilings, tables, or the like). As described herein, such processing can be performed using a machine learning model (e.g., neural network model, or the like). When a previously stored or predetermined transformed image is selected, application system 130 can be configured to obtain the transformed image (e.g., receive the transformed image from another system, such as generative artificial intelligence system(s) 140, retrieve the image from a database, computer memory, or the like, accessible to application system 130, or the like).

Application system 130 can be configured to provide the transformed image (or the annotated transformed image) to client system 110. Application system 130 can provide the transformed image (or the annotated transformed image) in response to the provision or selection of the original image.

In some embodiments, application system 130 can be configured to enable a user to modify the transformed image (or the annotated transformed image) to display a product at a location or in a segment of the transformed image (or annotated transformed image). In some embodiments, application system 130 can receive an indication of one or more products displayed or referenced by the webpage. Application system 130 can determine whether information enabling display of each of the one or more products is available. When such information is available for a product, application system 130 can provide an indication of such availability to client system 110. The indication of products displayed or referenced by the webpage can be received from one or more of the client system 110 or host system 120. Application system 130 can determine whether information enabling display of each of the one or more products is available using stored product information accessible to application system 130, or product information obtained from one or more of host system 120 or product system 150.

In some embodiments, application system 130 can be configured to receive from client system 110, a request to generate an updated version of the transformed or annotated transformed image. The request can include, or indicate, the image in which the product is to be displayed (e.g., the annotated transformed image or transformed image). The request can include, or indicate, the product for display in the image. The request can indicate a placement of the indicated product in the image (e.g., a segment or location in the transformed image or annotated image). For example, a user can interact with a graphical user interface of client system 110 to select a product and to indicate a segment or location in the annotated transformed image or a location in the transformed image. Client system 110 can display a selection of products and indications of segments or locations where the products can be placed in a transformed or annotated transformed image. A user can select a product and a segment or location. These selections can be indicated to application system 130 by client system 110.

In various embodiments, application system 130 can be configured to generate instructions for displaying an updated transformed image. These instructions can be generated in response to receipt of a request to display the updated transformed image. The updated transformed image can display a product in place of a segment of the transformed image (e.g., replacing flooring in the transformed image with product flooring) or at a location in the transformed image (e.g., placing a table at a location in the transformed image).

In some embodiments, application system 130 can be configured to provide, to client system 110, the generated instructions. In some embodiments, the instructions can include the transformed image, annotated transformed image, or an updated version of the transformed image. For example, the instructions can include the transformed image updated to display the product. Additionally or alternatively, the instructions can include a model of the product (e.g., a three-dimensional model, or the like).

In some embodiments, application system 130 can be configured to provide, to client system 110, updated instructions in response to user interactions with client system 110. For example, a user can interact with client system 110 to request repositioning or reorientation of the product in the updated transformed image. Client system 110 can be configured to provide a request for updated instructions to application system 130, which can generate instructions to reposition or reorient the product in the updated transformed image. For example, the instructions can include an updated version of the updated transformed image with the product repositioned or reoriented in accordance with the request provided by client system 110.

Generative artificial intelligence system(s) 140 can include one or more systems configured to host one or more generative artificial intelligence models consistent with disclosed embodiments. In some embodiments, generative artificial intelligence system(s) 140 can be or include a computing system, such as a desktop, workstation, server, server cluster, cloud computing environment (e.g., Amazon Web Services™ (AWS), Microsoft Azure™, IBM Cloud™, Google Cloud Platform™, Cisco Metapod™, Joyent™, vmWare™, or the like), or other suitable computing system.

In some embodiments, generative artificial intelligence system(s) 140 can be configured to receive application programming interface (API) requests over network 160. Such requests can include an input and request an output. For example, generative artificial intelligence system(s) 140 can receive from application system 130 an API request including or specifying an original image and a style conditioning prompt. The API request can specify that a generative artificial intelligence system create a transformed image using the original image and a style conditioning prompt. The API request can specify that generative artificial intelligence system(s) 140 send the transformed image to application system 130. In some embodiments, generative artificial intelligence system(s) 140 can be configured to host multiple generative artificial intelligence models. In such embodiments, the API request can specify a particular artificial intelligence model for use in generating the transformed image. In some embodiments, generative artificial intelligence system(s) 140 can be configured to determine the appropriate artificial intelligence model for use in generating the transformed image based on the content of the API request (e.g., the content of the style conditioning prompt, such as whether the style conditioning prompt includes textual input or is merely an image). In some embodiments, the generative artificial intelligence models can include models configured to accept textual style conditioning prompts, audio style conditioning prompts, image style conditioning prompts, or multi-modal models that combine two or more style conditioning prompt modalities.

In some embodiments, application system 130 and generative artificial intelligence system(s) 140 can be combined. For example, the artificial intelligence models can be special-purpose models developed for use consistent with disclosed embodiments and hosted by application system 130 (or another system provided by the same entity), as opposed to being general-purpose generative artificial intelligence models hosted by third parties. For example, existing suitable generative artificial intelligence models can be fine-tuned or trained for the task of generating transformed images given original images and style conditioning prompts. In some embodiments, such fine-tuning or training can include modifying the architecture of the existing artificial intelligence model (e.g., by adding additional layers before or after the existing model, incorporating the model into a pipeline including additional models, or the like). Such training can be performed according to known methods. In some embodiments, some style conditioning prompts can be processed using general-purpose generative artificial intelligence models hosted by third parties, while other prompts can be processed using special-purpose models hosted by application system 130 (or another system provided by the same entity).

Product system 150 can be configured to maintain information concerning products that can be displayed in images, consistent with disclosed embodiments. Such information can include product images, three-dimensional models of products, or the like. In some embodiments, product system 150 can be or include a computing system, such as a desktop, workstation, server, server cluster, cloud computing environment (e.g., Amazon Web Services™ (AWS), Microsoft Azure™, IBM Cloud™, Google Cloud Platform™, Cisco Metapod™, Joyent™, vmWare™, or the like), or other suitable computing system.

In some embodiments, product system 150 and host system 120 can be associated with different entities. For example, as described herein, host system 120 can be associated with a provider of the original image selected by the user (e.g., a real-estate listing company such as Zillow, or Redfin) while product system 150 can be associated with a provider of the products (e.g., a consumer goods store such as Home Depot, Walmart, or the like). In some embodiments, product system 150 and host system 120 can be associated with the same entities. For example, product system 150 and host system 120 can both be associated with the provider of the original image. In some embodiments, product system 150 and host system 120 can be implemented as a single system, or as separate parts of a combined system.

Product system 150 can be configured to interoperate with application system 130 or host system 120 to provide product information, such that application system 130 or host system 120 can in turn make the product information available to client system 110. The disclosed embodiments are not limited to any particular information transfer sequence from product system 150 to client system 110. In some embodiments, product system 150 can provide the information to application system 130, which can in turn provide the information to client system 110. In some embodiments, product system 150 can provide the information to host system 120, which can in turn provide the information to client system 110.

Network 160 can facilitate communication and sharing of information between client system 110, host system 120, application system 130, generative artificial intelligence system(s) 140, and product system 150. Network 160 may be any type of wired or wireless network that provides communications, exchanges information, and/or facilitates the exchange of information. For example, network 160 may be the Internet, a Local Area Network, a Wide Area Network, a cellular network, a public switched telephone network (“PSTN”), or other suitable connection(s) that enables transmission of information between the components of system 100. Network 160 may support a variety of electronic messaging formats and may further support a variety of services and applications for communicating between two or more of client system 110, host system 120, application system 130, generative artificial intelligence system(s) 140, and product system 150.

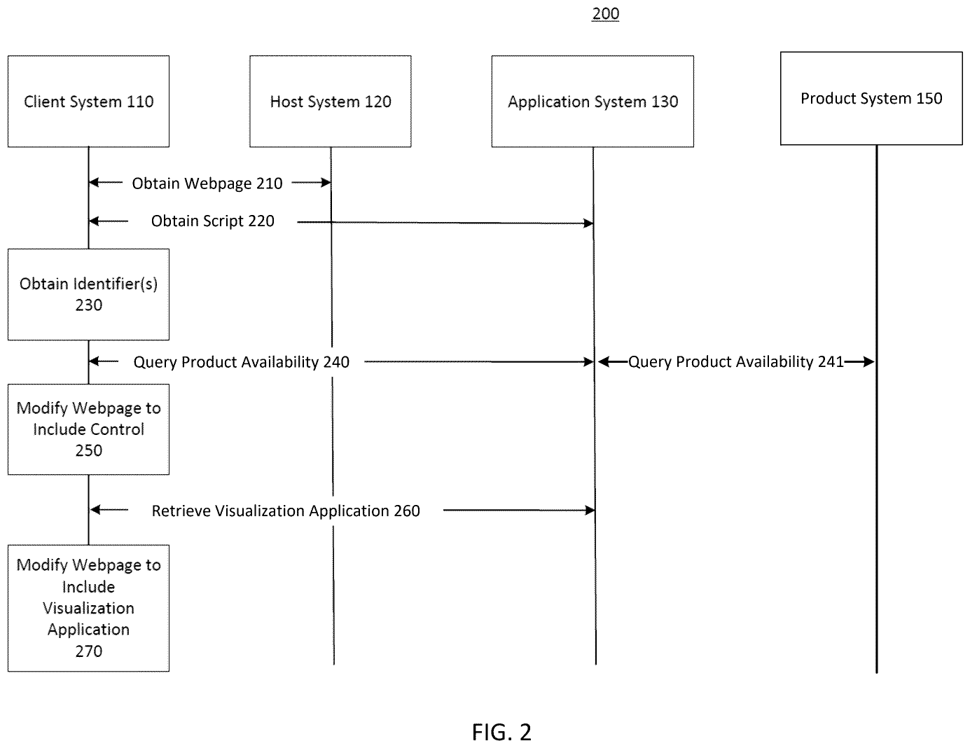

FIG. 2 depicts a method 200 for initializing a visualization application, in accordance with disclosed embodiments. A webpage received from host system 120 and displayed by client system 110 can be modified using data and instructions received from application system 130 to display the visualization application. In this manner, the visualization application can be integrated into webpage provided by a host website, allowing the user to visualize products without having to leave or reload the website. In this manner, the visualization application can modify a webpage (which need not originally support single-page application functionality) to provide single-page application functionality. Furthermore, method 200 can use a script to automate integration of the visualization application into the webpage. By using such a script, maintenance and development of the visualization functionality can be separated from maintenance and development of the webpage. In some embodiments, integration of the visualization functionality into the webpage may then require minimal modification of the webpage (e.g., adding a script tag, as described herein).

In step 210, client system 110 can obtain a webpage from host system 120. Client system 110 can obtain the webpage through a network connection established with host system 120 according to network protocol (e.g., using an HTTP request, or the like). Host system 120 can provide the webpage in response to a request received from client system 110. The disclosed embodiments are not limited to a particular method of obtaining the webpage from host system 120.

The webpage can include code and instructions (e.g., Hypertext Markup Language or the like) for displaying content in a browser of client system 110. In some embodiments, the webpage can include image upload functionality. In some embodiments, the content can include images. For example, the webpage can be a page of a real estate platform associated with a particular property and the content can include images of rooms or spaces on the property. In some embodiments, the content can further include product information about one or more products that could be placed or installed in the rooms or spaces on the property. In some embodiments, the product information can include product name, product brand, product category, model numbers, serial numbers, stock keeping units (SKUs), product color options, pricing information, product dimensions, product availability and inventory information, product installation information, or similar information about the product.

In some embodiments, the webpage can include vendor product code information usable to associate a product with visualization information for the product. In some embodiments, vendor product code information can be scrapable from the webpage. In various embodiments, the visualization information can be associated with an identifier for the product. The identifier may be unique for a combination of product and host system 120 (or product provider associated with host system 120), or unique for a combination of product, product type, and host system 120 (or product provider associated with host system 120).

Vendor product code information included in the webpage can be used to determine, create, or recover the identifier, enabling retrieval of the visualization information. For example, a stock keeping unit (SKU) number or Universal Product Code (UPC) for a product can serve as an identifier, associating the product with visualization information. The webpage can include the SKU number for the product. As an additional example, an identifier can be created (e.g., using one or more string operations) from two or more items of product information for a product (e.g., by concatenating the product name, product brand, and product color; or the like). The webpage can include the two or more items of product information for a product, enabling the identifier to be recreated by scraping the two or more items of product information from the webpage.

In step 220, client system 110 can obtain a script from application system 130. Client system 110 can obtain the script through a network connection established with application system 130 according to network protocol (e.g., using an HTTP request, or the like). The disclosed embodiments are not limited to a particular method of obtaining the webpage from application system 130.

In some embodiments, application system 130 can provide the script in response to a request received from client system 110. Client system 110 can generate the request while processing the webpage. For example, the webpage can include instructions (e.g., an HTML <script> tag) that, when parsed or executed by client system 110, cause client system 110 to request the script from application system 130. In some embodiments, in addition to the location of the script, the instructions can indicate a type, language, or version of the script (e.g., JavaScript or another suitable scripting language), or other information used in parsing or executing the script by client system 110. The disclosed embodiments are not limited to a particular scripting language or script format.

In some embodiments, the script can be specific to at least one of the webpage, host system 120, a product provider associated with host system 120, or a product type or category. In various embodiments, application system 130 can provide a previously generated script. In some embodiments, application system 130 can provide a script generated in response to the request. A script generated in response to the request can be specifically tailored to each request by client system 110.

Although depicted in FIG. 2 as two separate steps, in some embodiments, steps 210 and 220 can be performed as one step. For example, host system 120 can store a cached copy of the script, mirroring the script stored in the application system 130, and transmit the copy of the script to client system 110 with the webpage or after the website is transmitted.

In step 230, according to the script obtained in step 220, client system 110 can obtain identifiers for each of any products described or referenced in the webpage. In some embodiments, the script can configure client system 110 to scrape or parse the webpage for vendor product code information. For example, client system 110 can be configured to extract vendor product code information, as described herein, from a Document Object Model (DOM) of the webpage. In some embodiments, the vendor product code information can be stored in a predetermined location in the webpage (e.g., at a known location within a particular document element, within a hidden or displayed form element, within an element with a known name or id, or the like). In some embodiments, the vendor product code information can be extracted from the URL of the webpage. The script, which can be specific to the webpage, can cause client system 110 to extract the vendor product code information from the predetermined location in the webpage. In various embodiments, the script can extract the product information by searching the source code of the webpage for text with predetermined characteristics (e.g., product names, descriptions, colors, serial numbers, model numbers, or the like). In some embodiments, such searching can be performed using regular expressions or the like. The disclosed embodiments are not limited to embodiments in which client system 110 obtains all identifiers for all products described or referenced in the webpage. As would be appreciated by those of skill in the art, client system 110 may only attempt or be able to obtain identifiers for each of a subset of the products described or referenced in the webpage.

In some embodiments, client system 110 can be configured by the script to generate the identifier from the vendor product code information. For example, the identifier can be generated by applying one or more string operations to items of the vendor product code information (e.g., concatenating product name, brand, model number, and color to generate an identifier for the product).

In some embodiments, the product information can be included in the URL requesting the script as a parameter or part of the address. In these instances, the product information may have been transmitted to application system 130 prior to receipt of the script by client system 110. Application system 130 can then transmit a script that has been tailored to match the product.

In some embodiments, client system 110 can be configured by the script to manage user identity or session information. For example, in some embodiments, client system 110 can be configured by the script to place or check cookies identifying the user or establishing a session. To continue this example, when client system 110 lacks a current user session cookie, client system 110 can be configured by the script to generate such a cookie (e.g., by requesting a session or user identifier from application system 130 and storing the obtained information in the cookie). This cookie may be, or may be treated as, a first party cookie by client system 110. For example, the cookie can be associated with a domain of host system 120. Accordingly, this cookie may not be blocked by ad blockers or third-party cookie blockers. If a current user session cookie does exist in client system 110, but application system 130 does not recognize a corresponding session, client system 110 can be configured by the script to request application system 130 create a new user session associated with the user or with client system 110.

In step 240, according to the script obtained in step 220, client system 110 can query application system 130 for visualization information corresponding to the identifier(s) obtained in step 230. The query, and the response to the query, may not cause client system 110 to reload the webpage. For example, the query can be transmitted to application system 130 using Asynchronous JavaScript+XML (AJAX) techniques, or the like, and the data transmitted with the query can be organized in the form of JavaScript Object Notation (JSON), or the like. As an additional example, the query can be as simple as a URL pointing to a predetermined location in application system 130. The visualization information may be present at that location.

In response to the query, application system 130 can determine whether visualization information corresponding to the identifier(s) is available. In some embodiments, application system 130 can compare the identifier(s) to a list or database of products having visualization information. Application system 130 can transmit to client system 110 an indication of whether visualization information corresponding to the identifier(s) is available.

In some embodiments, application system 130 can communicate with product system 150 to determine whether visualization information corresponding to the identifier(s) is available. For example, application system 130 can provide the identifier(s) to product system 150, which may in turn compare them to a list or database of products having visualization information. In some embodiments, application system 130 can identify product system 150 based on the obtained identifiers. In some embodiments, application system 130 can identify product system 150 based on information obtained from host system 120. For example, host system 120 may directly provide information to application system 130 identifying product system 150, or may encode information identifying product system 150 into the webpage. In such embodiments, product system 150 can transmit to application system 130 (or directly to client system 110) an indication of whether visualization information corresponding to the identifier(s) is available.

In step 250, when visualization information is available for a product and according to the script obtained in step 220, client system 110 can modify the webpage to display at least one control. The control can be an interactive element in the webpage, for example, a button, a toggle, or the like. In some embodiments, the control may have been included in the webpage received from host system 120, but may be inactive (e.g., disabled, hidden, or the like). When the query indicates that visualization information is available for the product, client system 110 can modify the webpage to activate the control (e.g., permitting the control to be interacted with by a user). In some embodiments, the control may not have been included in the webpage received from host system 120. The control may then be added to the webpage. For example, client system 110 can be configured by the script to modify the webpage to include a selectable button at a location associated with the product. As the script may be specific to the webpage or to host system 120, the modification can preserve the look and feel of the webpage. Thus, the control can be displayed in a manner that appears natural to the user and without disrupting the user experience.

In step 260, when visualization information is available for a product and according to the script obtained in step 220, client system 110 can retrieve a visualization application from application system 130. In some embodiments, client system 110 can retrieve a visualization application in response to selection of the control (e.g., by a user interaction) in the modified webpage. For example, selection of the control can trigger an event. The script can handle the event, causing client system 110 to retrieve the visualization application from application system 130. For example, when the webpage is modified to display a button control, a selection of the button by a user can cause client system 110 to retrieve the visualization application.

In step 270, when visualization information is available for a product and according to the script obtained in step 220, client system 110 can modify the webpage to display the visualization application. The visualization application can enable the user to select an image and modify the image to display the product, as described herein. In some embodiments, client system 110 can be configured by the script to modify the webpage to include a container, such as an iframe, or the like. Client system 110 can then load the retrieved visualization application into the container. The disclosed embodiments are not limited to use of a container. Other modifications resulting in display of the visualization application are also envisioned, including addition of a layer over the existing webpage, opening a new tab or a new window to display the visualization application, or removing or rearranging one or more webpage elements to create space for displaying the visualization application.

The operations of method 200 have been labeled and described sequentially, for convenient description. As would be appreciated by those of skill in the art, the indicated sequence is not intended to be limiting. Steps may be rearranged or combined, or additional steps may be added. For example, in some embodiments, a single operation can include querying product availability (step 240) and obtaining the script (step 220). For example, the webpage obtained in step 210 can contain an URL pointing to the location of the script and at least one parameter can be combined with the URL, in effect querying availability of visualization information for the product. Similarly, the visualization application can be retrieved prior to selection of the control in the modified webpage. The visualization application may not be integrated into the webpage or may be integrated into the webpage but set to “invisible” or “inactive,” until the control is selected.

In some embodiments, the webpage may be automatically modified to include the visualization application. For example, rather than modifying the webpage to include the control, and then modifying the webpage to include the application when the control is selected, the script can configure client system 110 to automatically load the visualization application. In some such embodiments, the visualization application can be automatically loaded in response to a determination that product information is available. In other such embodiments, the visualization application can be automatically loaded without (or before) determining whether product information is available.

In some embodiments, the visualization application can be provided as a stand-alone application. For example, a user can interact with application system 130 through an app or a webpage provided by application system 130. The user can interact with application system 130 to provide an original image, view a transformed image (or annotated transformed image), provide selections for updating the transformed image, as described herein, and view the updated image.

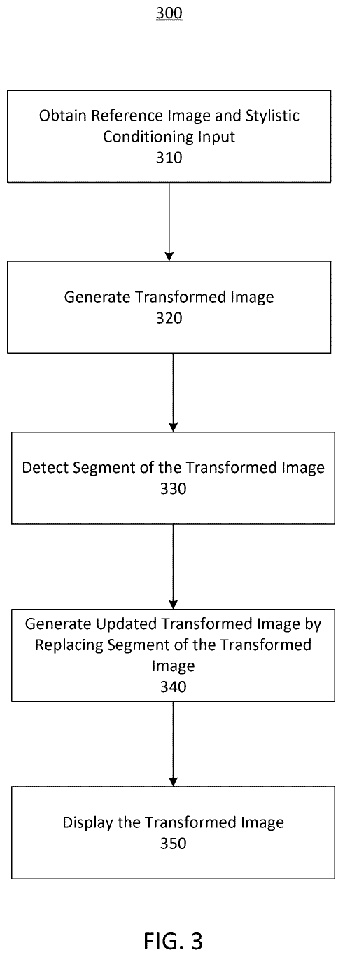

FIG. 3 depicts a method 300 for generating a transformed image, consistent with disclosed embodiments. In some embodiments, method 300 can be performed using system 100 as disclosed in FIG. 1. In some embodiments, method 300 can be performed using a single page application and visualization application as described above with reference to FIG. 2. However, the disclosed embodiments are not so limited. For example, method 300 can be performed using a multi-page application configured to load a new webpage whenever the user submits data or refreshes the webpage. Likewise, method 300 can be performed without using a visualization application. In such embodiments, generation of an updated transformed image can be handled by an application system (e.g., application system 130, or the like) and the resulting image can be provided to the client system as a new webpage. As may be appreciated, intermediate architectures can also be used that combine elements of single-page and multi-page applications. In some embodiments, method 300 can be performed using an additional or alternative system and/or arrangement of disclosed systems.

In step 310 of method 300, a reference image (e.g., an original image as described with respect to FIG. 1) and a style conditioning input (e.g., a style conditioning prompt as described with respect to FIG. 1) can each be obtained (e.g., as described with respect to FIG. 1). In some embodiments, the reference image can be selected by a user following display of the reference image to the user (e.g., in a visualization application running on a client, as described herein). In some embodiments, the reference image can be selected by a user without first displaying the reference image to the user. In some embodiments, a resource identifier can be obtained. For example, a selection of a resource identifier can be obtained (e.g., by an application system from a client system). The selection can be the resource identifier, or an indication of a resource identifier. For example, given a previously obtained set of resource identifiers (e.g., received from a client system by an application system during parsing of a webpage, or during a determination of whether images suitable for restyling are present in the webpage), the indication can specify a resource identifier in the set. Once the resource identifier is obtained, the corresponding reference image can be obtained using the resource identifier.

Consistent with disclosed embodiments, the style conditioning input can include at least one of text, audio, or image data. In some embodiments, characteristics of the reference image can be extracted and used to enrich the style conditioning input. For example, the stylistic conditioning prompt can be enriched to preserve or favor preservation of the detected architectural features, furnishings, or objects. As an additional example, when the style conditioning input is a textual prompt, characteristics of the reference image can be used to update the textual prompt, for example by replacing default words or phrases in the textual prompt, providing additional instructions, or remove unnecessary instructions. In some embodiments, such replacement, additions, or deletions can be performed based on predetermined rules or templates. In this manner, the detected characteristics of the reference image can feed back into the style conditioning input used to generate the transformed image.

In some embodiments, when the style conditioning input is an image input, the image input can be converted into a textual input using a machine learning model. The textual input can then be enriched (e.g., based on textual inputs provided by the user, or default textual inputs or textual templates) and used to condition the original image. Alternatively, the image style conditioning input can be provided to a generative artificial intelligence model configured to accept an image data input for conditioning the original image.

In step 320 of method 300, a transformed image can be generated. The transformed image can be in a style defined or influenced by the style conditioning prompt. The transformed image can be generated by applying the reference image and the style conditioning input to a generative machine learning model. The generative machine learning model can be trained to output images conditioned on the reference image and the style conditioning input. The generative machine learning model can be a diffusion model or any other suitable generative machine learning model. In some embodiments, the transformed image can then be displayed.

In some embodiments, the transformed image can be further processed. Such further processing can include increasing a resolution of the transformed image (e.g., using an artificial intelligence upscaling or super-scaling model, or the like). In some embodiments, increasing the resolution of the transformed image can improve the performance of subsequent image segmentation. Furthermore, increasing the resolution of the transformed image can improve the user experience.

In step 330 of method 300, segments of the transformed image can be detected. In some embodiments, segments of the transformed image can be identified as described herein. For example, segments of the transformed image corresponding to architectural features, furnishings, or objects can be detected using one or more machine learning models. Consistent with disclosed embodiments, surfaces in the transformed image can be detected. In some embodiments, these surfaces can be used to generate a 3D model of at least portions of the transformed image.

In step 340 of method 300, an updated transformed image can be generated by replacing a segment of the transformed image. As described with respect to step 330, a segment can correspond to an architectural feature, furnishing, or object. A user can provide an indication of a segment of the transformed image corresponding to an architectural feature, furnishing, or object (e.g., by selecting the segment using a graphical user interface as described herein). The user can also provide a replacement architectural feature, furnishing, or object (e.g., by selecting a corresponding product using a graphical user interface as described herein). For example, a user can indicate that the depicted floor be replaced with a floor of another material, or that a wall be repainted. In some embodiments, replacing an object in the transformed image can include depicting a user-selected product in place of the object.

The segment of the transformed image corresponding to the indicated architectural feature or furnishing can be replaced with a suitably scaled and oriented segment corresponding to the replacement architectural feature, furnishing, or object, as described herein. In some embodiments, such replacement can include the substitution of an architecture feature for another similar architecture feature (e.g., a column for a column in another style, a window for a window in another style), or furnishing for another similar furnishing (e.g., drapes in a first style for drapes in a second style, wallpaper in a first style for wallpaper in a second style), or an object for another similar object (e.g., one table for another, one painting for another). In some embodiments, such replacement can include a modification of the depiction of an architectural feature, furnishing, or object. For example, such replacement can include the placement of an object in front a selected segment (e.g., depicting a selected vase in front of a wall) or on a selected segment (e.g., depicting the selected vase on a table) or otherwise modifying the depiction of the selected segment corresponding to the architectural feature, furnishing, or object (e.g., adding drapes to a window or a portiere to a doorway)

In some embodiments, such replacement can be performed automatically. For example, an architectural feature, furnishing, or object depicted in the transformed image can be automatically replaced with a selected replacement. Such automated replacement can be performed based on detected characteristics of the transformed image (e.g., fidelity criteria; detected shape or dimensional characteristics of the architectural feature, furnishing, or object; a detected type or identifier of the architectural feature or furnishing; or the like).

In step 350 of method 300, the transformed image can be displayed. In some embodiments, the transformed image can be displayed as described herein. In some embodiments, the reference image, the transformed image, and the updated transformed image can be displayed in the same application or on the same device or display. For example, the reference image can be displayed to a user in a visualization application running on a client system. The user can interact with the client system to select the reference image for transformation (e.g., in step 310). The transformed image can be generated and then displayed to the user in the visualization application (e.g., in step 320). Following user interactions with visualization application (e.g., in step 340), an updated transformed image can be generated and displayed to the user (e.g., in step 350). In some embodiments, the reference image, the transformed image, and the updated transformed image can be displayed in different applications, or different displays of the same device, or on different devices.

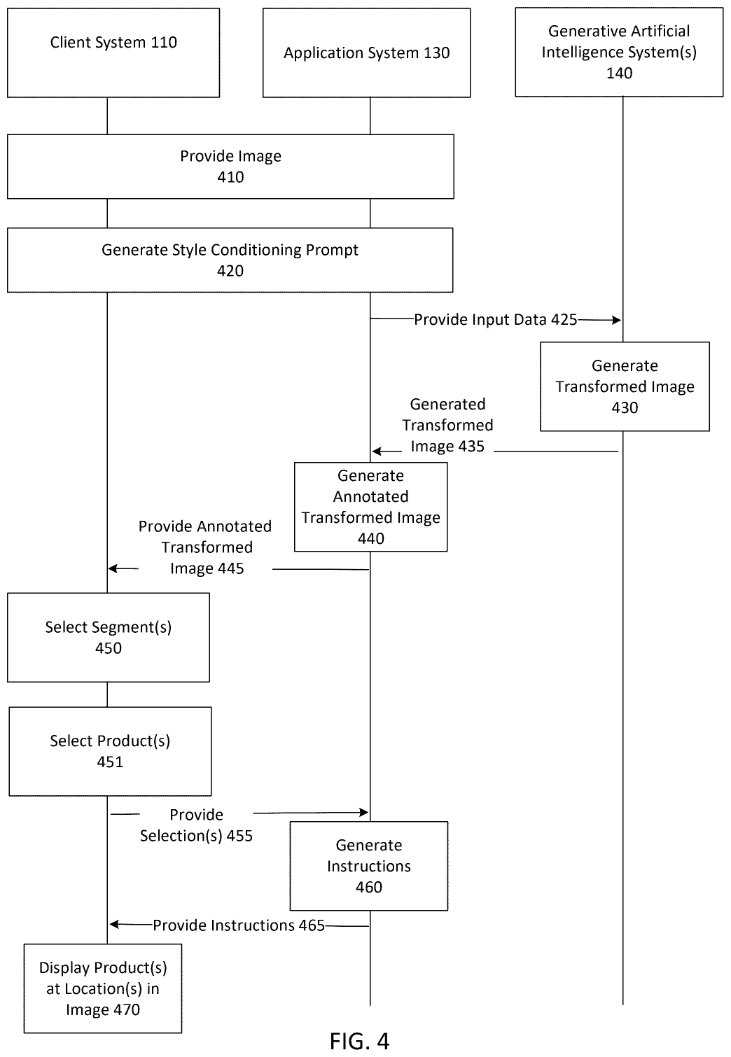

FIG. 4 depicts a method 400 for interacting with a visualization application, in accordance with disclosed embodiments. Method 400 can be an application for method 300 to the architecture disclosed in system 100. Accordingly, method 400 can be begin after or in response to modification of the webpage to display the visualization application (e.g., as in step 270, described previously with reference to FIG. 2).

In some embodiments, the visualization experience described in the present disclosure can be generalized to support multiple product types. For example, the script can determine the product types (such as flooring, furniture, or the like) based on the website content of host system 120, and load the visualization experience corresponding to the determined product type. Furthermore, the visualization application can determine the desired product type based on the contents of an uploaded image. For example, if only a wall is visible in the uploaded image, then only product or product type that can be applied to the wall, but not to the floor may be determined to be desirable.

In step 410, a user can interact with client system 110 to select an original image (and in some embodiments provide the original image to application system 130). In some embodiments, the original image can be of an interior or exterior of a structure, such as one or more rooms of a house. In some embodiments, client system 110 (e.g., the visualization application, or the like) can provide a graphical user interface with options for uploading an original image. In such embodiments, the user can interact with client system 110 to upload an original image to application system 130 (e.g., using the visualization application, or the like). In some embodiments, application system 130 can provide original images for selection by the user. For example, application system 130 can cause the visualization application to display a list, menu, catalog, or the like of original images. One or more of the original images can be selectable. In such embodiments, the user can interact with client system 110 to select one of the displayed original images (e.g., using the visualization application, or the like). In some embodiments, an indication of the selection can be provided to application system 130. For example, a resource identifier (e.g., a URL, or the like) of the selected image (or an indication of such a resource identifier) can be provided to application system 130. In some embodiments, the selected image can be sent to application system 130.

In some embodiments, when the client interacts with client system 110 to provide the original image, application system 130 can be configured to validate the original image. Such validation can include validating the form of the upload (e.g., file type, resolution, etc.) and the content of the image (e.g., image depicts an environment and not a person or animal, the environment is an interior environment, no objectionable content depicted, etc.).

In step 420, the user can interact with client system 110 to generate a style conditioning prompt. As described herein, the style conditioning prompt can be or include textual, audio, or image data. The style conditioning prompt can be configured to cause the generative artificial intelligence system to transform the original image to better conform with a particular style. In some embodiments, the user can interact with client system 110 to upload a style conditioning prompt to application system 130 (e.g., using the visualization application, or the like). In some embodiments, the user can interact with client system 110 to select a style conditioning prompt. For example, application system 130 can cause the visualization application to display a list, menu, catalog, or the like of controls corresponding to style conditioning prompts. One or more of the style conditioning prompts can be selectable. In such embodiments, the user can interact with client system 110 to select one of the controls (e.g., using the visualization application, or the like), thereby selecting the corresponding style conditioning prompts.

In some embodiments, when the client interacts with client system 110 to upload the style conditioning prompt, application system 130 can be configured to validate the style conditioning prompt. Such validation can include validating the form of the upload (e.g., file type, resolution, etc.) and the content of the style conditioning prompt (e.g., the style conditioning prompt depicts or describes an environment and not a person or animal, the style conditioning prompt depicts or describes an interior environment, no objectionable content depicted, etc.).

In such embodiments, the controls corresponding to style conditioning prompts can depict images in particular styles. The corresponding style conditioning prompt can be configured to cause the generative artificial intelligence system to transform the original image to better conform to the depicted style. For example, a control can be labeled “modern” and can depict a room in a modern style. The corresponding style conditioning prompt can be configured to cause the generative artificial intelligence system to transform the original image to better conform to a modern style. Similarly, a control labeled “traditional” can depict a room in a traditional style and be associated with a corresponding style conditioning prompt configured to cause the generative artificial intelligence system to transform the original image to better conform to a traditional style.

In some embodiments, the corresponding style conditioning prompts can be textual templates. The application system 130 can be configured to adjust these templates based on the original image. In some embodiments, application system 130 can detect (e.g., using one or more machine learning models, or another suitable automatic method) characteristics of the original image and use these detected characteristics to enrich the textual templates. For example, application system 130 can be configured to detect a room type of the original image and incorporate the room type into the style conditioning prompt. For example, a user may upload an original image of a kitchen and select the control labeled “modern.” The style conditioning prompt corresponding to the control labeled “modern” may be the textual template “Make this [room] look like a modern-style [room].” In some embodiments, application system 130 may detect that the original image is of a kitchen and update the textual template to be “Make this kitchen look like a modern-style kitchen.” In some embodiments, the detected room type can trigger the use of a particular textual template or the addition of content to the textual template. For example, detection of a “bedroom” room type can cause the textual template to become “Make this bedroom look like a modern-style bedroom. Make sure to include at least one bed at a suitable location in the bedroom without blocking any doors or closets.” As an additional example, detection of the “kitchen” room type can cause the textual template to become “Make this kitchen look like a modern-style kitchen. Make sure to include no more than one sink with a faucet, one stove, and one refrigerator at suitable locations in the kitchen.” As an additional example, detection of a bike object in a “living room” room type can cause the textual template to become “Make this living room look like a modern-style living room. Make sure to keep the bike object in the transformed image.” As an additional example, detection of a bike object in a “kitchen” room type can cause the textual template to become “Make this kitchen look like a modern-style kitchen. Make sure to discard the bike object from the transformed image.” In some embodiments, generating the enriched style conditioning prompt can include modifying style conditioning prompt to indicate the presence and location of an object detected in the image.

In this manner, detected characteristics of the image can be used to enrich the style conditioning prompt, which can then be used to transform the image, thereby improving the performance of the generative artificial intelligence model in transforming the original image.

In step 425, application system 130 can provide to generative artificial intelligence system(s) 140 a request to generate a transformed image. This request can be provided through an API call or the like. In some embodiments, the request can include input data. The input data can include the original image and the style conditioning prompt, and/or values generated using the input data and the style conditioning prompt (e.g., embeddings, or the like). The request can be provided using network 160. The disclosed embodiments are not limited to any particular method or protocol for providing the request. As may be appreciated, in some embodiments application system 130 can host the relevant generative artificial intelligence model(s). In such embodiments, provision of the request can be performed through message-passing, inter-process communication, a procedure, method, or function call, or any other method appropriate for the architecture of application system 130.

In some embodiments, client system 110 can convert the original image into a predetermined format before transmitting it to application system 130, while in some other embodiments, client system 110 can transmit the original image to application system 130 without converting the original image. The disclosed embodiments are not limited to a particular format for transferring the original image. In some embodiments, client system 110 can provide metadata concerning the original image. For example, depth information can be associated with the original image. In some embodiments, client system 110 can capture the depth information using measurement methods (e.g., lidar, ultrasound, or other hardware-based measurement methods like) or image processing methods (e.g., using one or more images from multiple cameras, multiple images from the same camera, machine-learning models trained to detect depth from one or more images, or other suitable methods). The disclosed embodiments are not limited to a particular method of acquiring such depth information. Such metadata can be provided to generative artificial intelligence system(s) 140 to improve the generation of the transformed image.

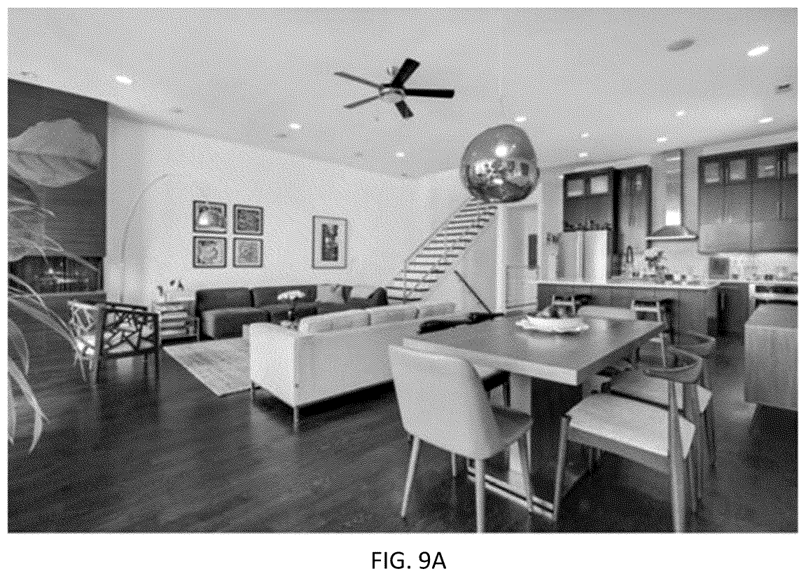

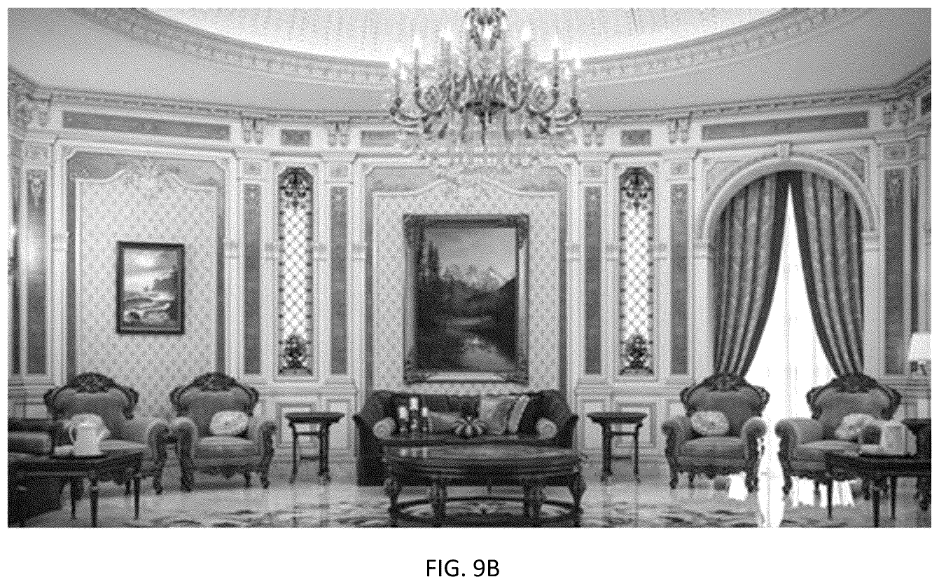

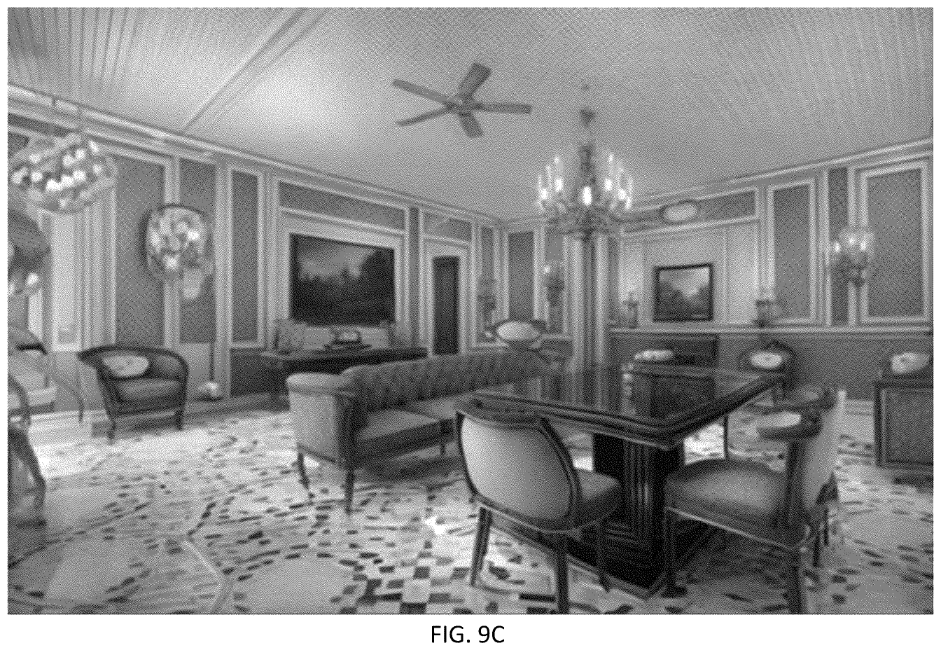

In step 430, generative artificial intelligence system(s) 140 can generate the transformed image. As described herein, generating the transformed image may include selecting an appropriate artificial intelligence model. For example, the selected artificial intelligence model can be configured to accept a style conditioning prompt in the provided modality (or embedded values or the like). The original image and style conditioning prompt (or values generated using the original image and/or style conditioning prompt) can be input to the artificial intelligence model. The style conditioning prompt (or values generated based on the style conditioning prompt) can bias generation of the transformed image stylistically toward the style specified in the style conditioning prompt. A representative example of an original image, image style conditioning prompt, and resulting transformed image is provided in FIGS. 9A to 9C.

In some embodiments, enriched textual templates corresponding to selected controls (or textual style conditioning prompts or transcribed audio style condition prompts) can be processed by a first generative artificial intelligence model, while uploaded image style conditioning prompts can be processed by another generative artificial intelligence model.

In step 435, generative artificial intelligence system(s) 140 can provide to application system 130 a response to the request from application system 130. Generative artificial intelligence system(s) 140 can provide the response using network 160. The response can include the transformed image. This response can be provided as a response to an API call, or in another suitable manner. The request can be provided using network 160. The disclosed embodiments are not limited to any particular method or protocol for providing the request. As may be appreciated, in some embodiments application system 130 can host the relevant generative artificial intelligence model(s). In such embodiments, the provision of the response to the request can be performed through message-passing, inter-process communication, a procedure, method, or function return, or any other method appropriate for the architecture of application system 130.

In step 440, application system 130 can generate an annotated transformed image using the transformed image received from generative artificial intelligence system(s) 140 in step 435. In some embodiments, application system 130 can be configured to generate the annotated transformed image by identifying one or more segments in the transformed image. Application system 130 can generate the one or more segments by performing semantic segmentation of the transformed image or object detection in the transformed image. Consistent with disclosed embodiments, the segment can correspond to the output of the semantic segmentation or to a portion of the transformed image associated with a detected object, without limitation. As described previously, semantic segmentation or object detection can be used to identify image pixels associated with a shared object represented in the image, thereby enabling objects represented in the image to be identified. As a non-limiting example, semantic segmentation or object detection can be used to identify architectural features, furnishings, or the like in the image. Each of these identified portions of the image can be a segment. In some embodiments, application system 130 can use one or more machine learning models to perform the semantic segmentation of the image or object detection in the image, such as using a convolutional neural network built on an AlexNet, VGG-16, GoogLeNet, ResNet, or other suitable architecture. In some embodiments, application system 130 can be configured to use multiple machine learning models to perform semantic segmentation of the image or object detection in the image. The multiple machine learning models can be trained to identify differing portions of the image. In some embodiments, application system 130 can be configured to generate an estimated 3D model of the environment depicted in the transformed image (or of portions thereof, such as architecture features or furnishings detected within the transformed image).

In some embodiments, the transformed image can be preprocessed prior to image segmentation. For example, a resolution of the image can be increased. Such upscaling or super-scaling can improve the performance of the image segmentation process (and may also improve user experience).

In some embodiments, the annotated transformed image can include the transformed image and metadata specifying the identified segments in the transformed image. The disclosed embodiments are not limited to any particular implementation of the annotated transformed image. For example, the metadata can include segmentation masks and associated labels, a 3D model of the environment depicted in the transformed image (or portions thereof), or any other suitable implementations for specifying the identified segments in the transformed image.

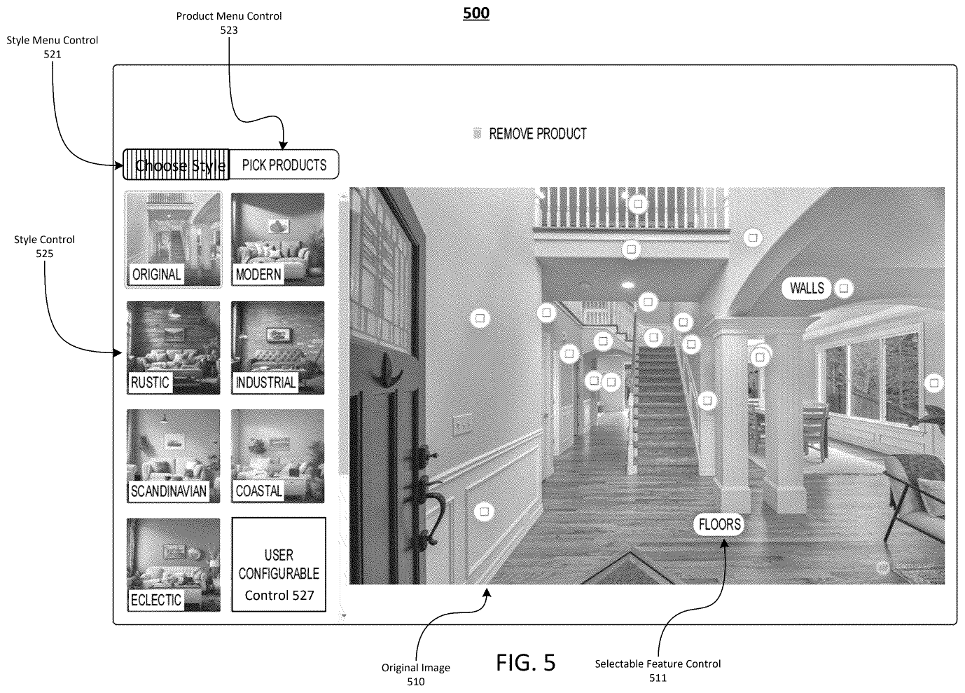

In step 445, application system 130 can provide the annotated transformed image to client system 110. Application system 130 can provide the annotated transformed image using network 160. Client system 110 can be configured to display the annotated transformed image. For example, client system 110 can display the transformed image with graphical indicators identifying the locations of the segments in the transformed image. In some embodiments, application system 130 can identify a product type corresponding to a segment in the transformed image. Such product types can also be used to generate labels displayed in association with the segment in, for example, the visualization application. By way of example, FIGS. 5 to 8 depict exemplary annotated (and updated) images with graphical indicators identifying the locations of the segments in the transformed image.

In step 450, the user can interact with client system 110 (e.g., using visualization application or the like) to obtain user selections of one or more segments. In some embodiments, the user selections can be received via user interactions with the displayed annotated transformed image. In some instances, the user can interact with the displayed graphical indicators. In such instances, each graphical indicator can be (or trigger display of) an interactive interface capable of receiving a user selection. For example, if client system 110 is a mobile device having a touch screen, a user can touch the one or more of the graphical indicators to select a segment in the annotated transformed image. The disclosed embodiments are not limited to any particular type of interactive interface. Exemplary interfaces could include radio buttons, check boxes, a drop-down menu associated with the overall image (the graphical indicators being menu entries within the drop-down menu), or the like.

In step 451, the user can interact with client system 110 (e.g., using the visualization application or the like) to obtain user selections of one or more products. In some embodiments, the user selections can be received via user interactions with a displayed graphical user interface. In some embodiments, client system 110 (e.g., the visualization application or the like) can be configured to display products in the graphical user interface based on the product type associated with the selected segment (e.g., a type of architectural feature, furnishing, or object, etc.). For example, when user selects a segment associated with the product type “Floor,” client system 110 can display products that are relevant to “Floors,” such as tiles, carpets, etc. In some instances, the user can interact with the graphical user interface to select, for one or more segments, a corresponding product.

The disclosed embodiments are not limited to selecting a segment, then a product. In some embodiments, a product can be selected prior to selecting a corresponding segment. In some such embodiments, client system 110 (e.g., visualization application or the like) can then emphasize the graphical indicators for corresponding segments (e.g., select flooring and floor segments are emphasized). In some embodiments, a user can select a product and then select a location in the transformed image for placement of the product, without reference to a particular segment.

In step 455, application system 130 can receive selections from client system 110 (e.g., using visualization application or the like). Client system 110 can provide the instructions using network 160. For example, when the user selects a particular graphical indicator and product on client system 110, these selections can be communicated by client system 110 to application system 130. Similarly, when the user selects a particular product and location in the transformed image on client system 110, these selections can be communicated by client system 110 to application system 130.

In step 460, application system 130 can generate instructions for updating the annotated transformed image. In some embodiments, application system 130 can generate instructions for modifying the transformed image to display the selected product in the selected segment of the annotated transformed image. In some embodiments, application system 130 can generate instructions for modifying the transformed image to display the selected product in a specified location in the annotated transformed image.

In some embodiments, application system 130 can be configured to maintain a data storage subsystem (e.g., a database) storing product models. Alternatively or additionally, application system 130 can be configured to obtain such product models from product system 150. In response to a request from client system 110 indicating a selected product, application system 130 can be configured to retrieve visualization information for the selected product. As described herein, the model of the selected product can include spatial information and/or surface detail information.

Application system 130 can, in some embodiments, be configured to retrieve a product model for the selected product and include the product model in the instructions. Application system 130 can alternatively or additionally modify the annotated transformed image or transformed image using the product model and then include this updated transformed image in the instructions.

Application system 130 can modify the annotated transformed image or transformed image by overwriting a segment in the annotated transformed image with an appropriately oriented and scaled version of the product, or by rendering the product model at a particular location in the selected image. Application system 130 can be configured to use a suitable rendering method, such as a machine-learning model (e.g., a generative neural network, or the like) trained to perform such rending, polygon-based rendering, scanline rendering, ray tracing, rasterization, or the like. Such rendering can include determining pixels in the selected image obscured by the rendered product model and replacing these pixels with corresponding pixels of the rendered product model. For example, application system 130 can determine that a wall clock may cover an area of the wall and replace the pixels in the selected image with corresponding pixels in a rendering of the wall clock. In various embodiments, the particular location can be determined based on information included in the request. For example, the user can specify a location for a product (e.g., a lamp) in the image (e.g., on a table depicted in the image). In some embodiments, the particular location can be determined by application system 130. For example, application system 130 can determine suitable locations in the image based on semantic segmentation or object detection, as described herein, and a type of the product. In this example, application system 130 may determine that the product is a lamp and that the image includes a surface suitable for placement of a lamp (e.g., a tabletop, countertop, shelf, or the like). Application system 130 may then render the lamp on the suitable surface.

Application system 130 can modify the selected image by painting an image of the product on suitable portions of the selected image, using surface detail information for the product and a 3D model of the image. As described above, application system 130 can perform semantic segmentation on the image or object detection in the image to associate classes with pixels in the image. Within the present context, class may be used to designate the type of object present in the image. In some instances, when a type of the product matches one of the classes, an image of the product generated using the surface detail information can be painted over pixels associated with that class. For example, when the product is a type of flooring, application system 130 can replace portions of the selected image associated with the class “floor” with corresponding texture-mapped portions of the flooring.

In step 465, application system 130 can provide the instructions to the client for displaying the updated transformed image. The instructions can be provided using network 160. The disclosed embodiments are not limited to any particular method or protocol for providing the instructions. In some embodiments, the instructions may include an updated transformed image displaying the selected product. In various embodiments, the instructions may include the transformed image (e.g., when the request in step 320 indicated an image option but did not include an uploaded image) and a rendered version of a product model (e.g., a rendered version of the product model, appropriately scaled and oriented such that it can be combined with the image, together with information enabling the client system to combine the images). In some embodiments, the instructions can include a product model for the selected product, together with instructions for rendering the product model and displaying the rendered product model in the transformed image. For example, the instructions can include a 3D model of the transformed image and results of semantic segmentation of the selected image or of object detection in the selected image (e.g., associations between pixels in the selected image).

In step 470, client system 110 can be configured to display the updated transformed image, using the received instructions. When the instructions include an updated transformed image, client system 110 can be configured to display the updated transformed image. When the instructions include a rendered product model and the transformed image, client system 110 can be configured to combine the rendered product model and the transformed image to generate the modified image. Client system 110 can then display the updated transformed image. When the instructions include the product model and instructions for rendering the product model and displaying the rendered product model in the transformed image, client system 110 can perform such rendering and display the resulting updated transformed image. For example, the instructions include a 3D spatial model of the product, surface detail information for the product, and a 3D model of the transformed image (e.g., the annotated transformed image including the metadata generated in step 440 and associated with the transformed image). The 3D model of the transformed image can include perspective information and depth information for at least some surfaces detected in the transformed image. Client system 110 can be configured to use the perspective and 3D model of the transformed image to render the product in the transformed image at location(s) or in segment(s) indicated by the user.

Optionally, in step 470, the client system 110 can be configured to further update the updated transformed image based on user interactions with the visualization application. For example, the user can interact with the visualization application to adjust the location and orientation of the displayed product in the updated transformed image. Such interactions may not require reloading of the webpage. For example, the user can rotate the product and move the product to place the product at a different location. In some embodiments, client system 110 can limit the range within which the product can be placed depending on the type of the product and the classification of pixels in the updated transformed image. The method may comprise identifying pixels in the updated transformed image having a classification associated with the type of product, and restricting placement of the product within the image to locations corresponding with the identified pixels having the classification associated with the type of product. For example, the user can move a carpet within the range of pixels identified as representing floors. In some embodiments, client system 110 can re-render the product image or/and re-combine the product image with the updated transformed image as described above. In some embodiments, client system 110 can transmit the user interaction to application system 130 and request display of the product in the transformed image with updated instructions. In these cases, the system can repeat steps 450 to 470.

FIG. 5 depicts a first view 500 of an exemplary graphical user interface for use with the method of FIG. 3 or 4. In some embodiments, such a graphical user interface can be provided by a webpage running on a client system (e.g., client system 110, or the like). In some embodiments, such a graphical user interface can be provided by a visualization application included in the webpage, as described herein. The view can depict an original image, a transformed image, an updated transformed image, or a combination thereof. In this example, the view depicts an original image 510 of the interior of a house. In this example, the original image may already have been segmented and annotated as described herein with regards to step 440 of FIG. 4. Accordingly, selectable feature controls are associated with the image. The selectable feature controls correspond to identified features in the image (e.g., selectable feature control 511 corresponds to a detected floor). The view includes a style menu control 521 (presently selected) and a product menu control 523. Selection of the style menu control can cause the graphical user interface to depict style controls (e.g., style control 525). Style controls can be associated with a style conditioning prompt. Selection of a style control can cause the graphical user interface to depict a transformed image, the transformed image being a version of the reference image in a style corresponding to the selected style control. Style controls can include pre-defined style controls (e.g., style control 525) or user configurable style controls (e.g., user configurable control 527). User configurable style controls can enable a user to provide a user-defined style conditioning input (e.g., by uploading an image, entering text into a text box, or speaking into a microphone), while pre-defined style controls can be associated with a predetermined style conditioning input template, as described herein. The style conditioning inputs can include text or images. For example, a predetermined textual style conditioning input can be the phrase “Make this [room] look like a modern [room]”, “Make this [room] look like a transitional [room]”, “Make this [room] look like a rustic [room]”, etc., for the controls depicted in FIG. 5. As an additional example, a user-defined, textual style conditioning input can be “the bedroom of a 10-year-old girl that loves anime” or “place a couch in the middle of the room and a standing lamp in each corner.” As a further example, a predetermined image style conditioning input can be a predetermined image (e.g., of an interior or the like). As a further example, a user-defined, image style conditioning input can be a picture of a room decorated with anime dolls and figurines. Selection of the product menu control 523 can cause the graphical user interface to depict product controls. A user can interact with a selectable feature control to select a feature and then interact with a product control to update the image to depict the corresponding product at the location of the feature in the image.

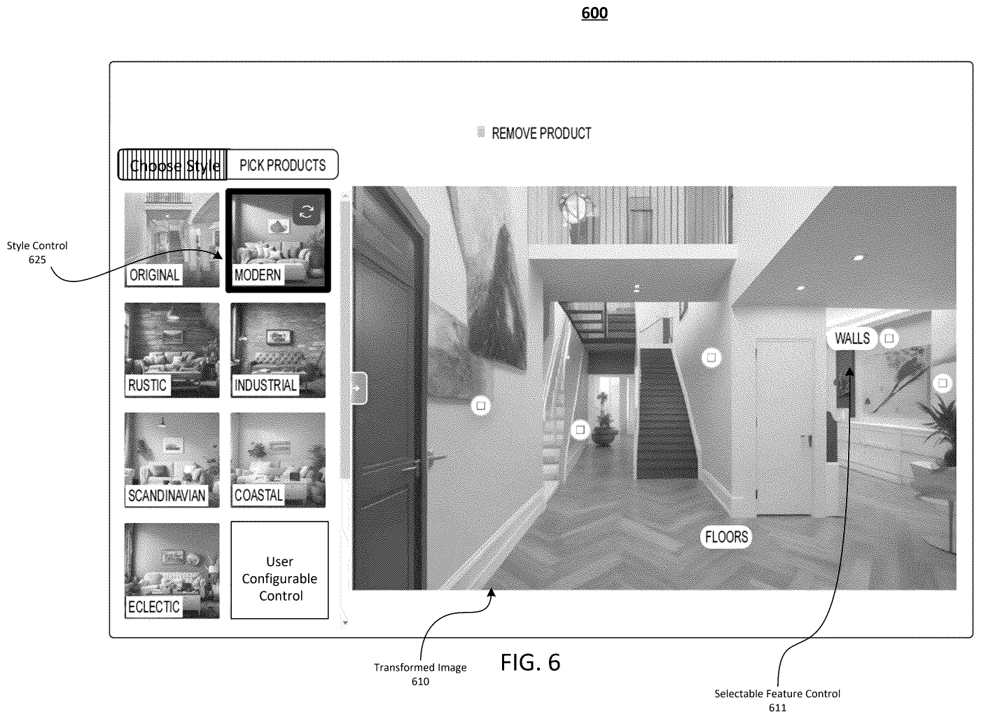

FIG. 6 depicts a second view 600 of the exemplary graphical user interface for use with the method of FIG. 3 or 4. The second view depicts a transformed version of the original image depicted in FIG. 5. In this case, the “modern” style control 625 has been selected and the transformed image 610 is the original image in a “modern” style. Selectable feature controls are associated with the transformed image (e.g., selectable feature control 611). The selectable feature controls correspond to identified features in the transformed image (e.g., a wall). As may be noted, the selectable features identified in the transformed image differ in number and location from the selectable features identified in the original image.

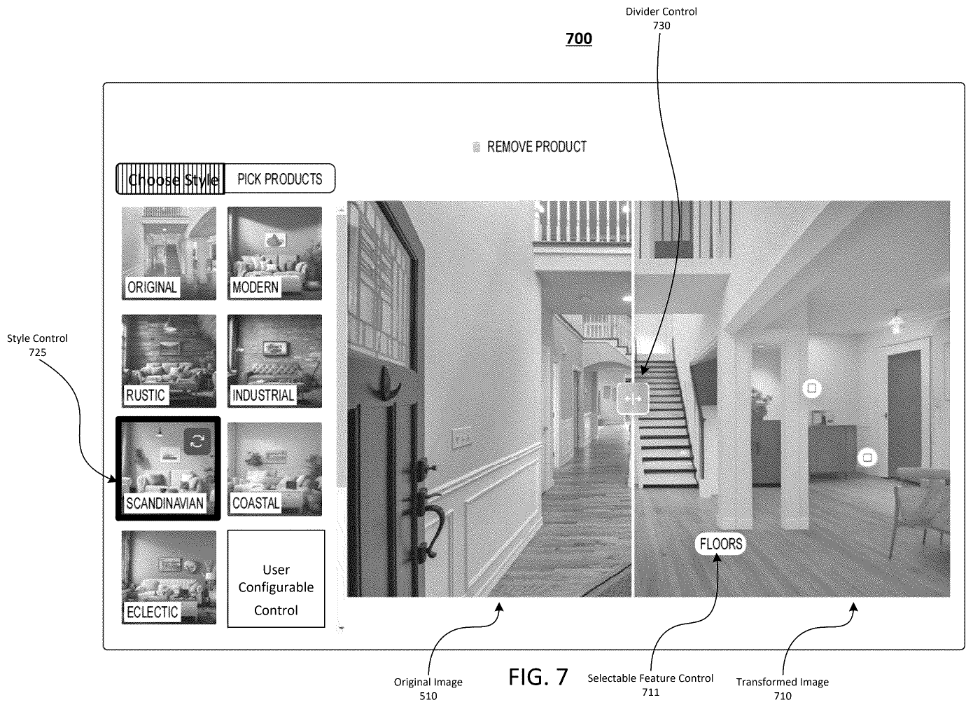

FIG. 7 depicts a third view 700 of the exemplary graphical user interface for use with the method of FIG. 3 or 4. The third view depicts a combination of the original image 510 depicted in FIG. 5 and a transformed version 710 of this original image. In this case, the “Scandinavian” style control 725 has been selected and the transformed image 710 is the original image 510 in a “Scandinavian” style. A moveable divider control 730 partitions the display into a portion showing the original image 510 and a portion showing the transformed image 710. A user can select and drag the control left or right in the image to reveal more or less of the transformed image (and correspondingly less or more of the original image). Selectable feature controls are associated with the transformed image (e.g., selectable feature control 711). The selectable feature controls correspond to identified features in the transformed image.

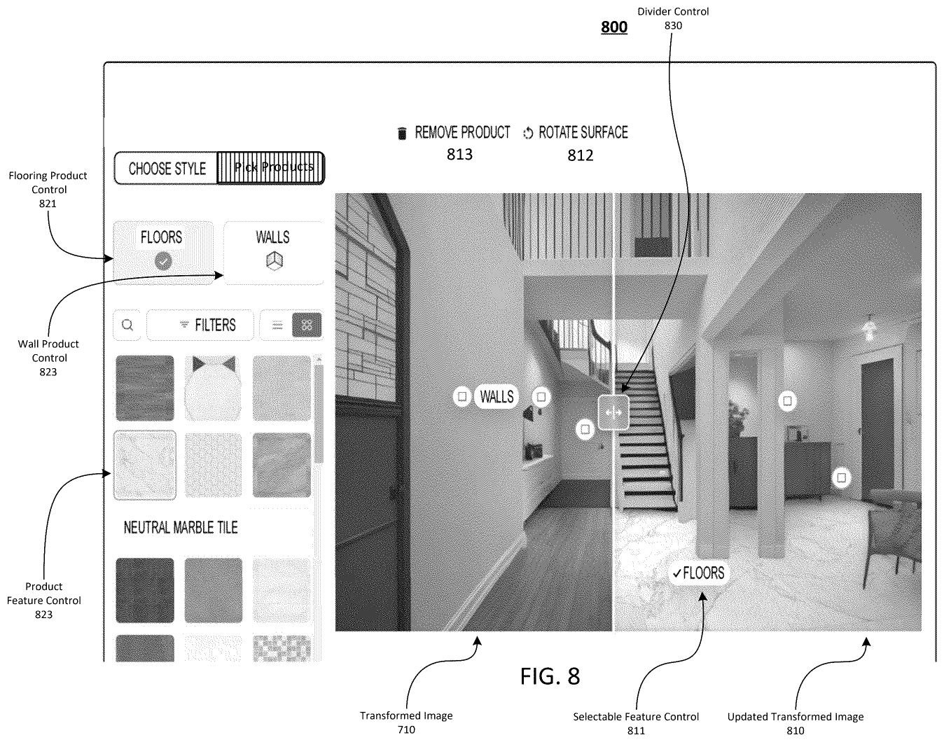

FIG. 8 depicts a fourth view 800 of an exemplary graphical user interface for use with the method of FIG. 3 or 4. The third view depicts a combination of the original image depicted in FIG. 5 and an updated version of the transformed image 810 depicted in FIG. 7. The product menu has been selected, causing the graphical use interface to display product controls for product options (e.g., flooring product control 821 and wall product control 823). Flooring product control 821 has been selected, causing the graphical user interface to display product features controls (e.g., product feature control 825, corresponding to “neutral marble tile”). Product feature control 825 has been selected and a feature control for the floor 811 has been selected. The graphical user interface therefore updated the image consistent with FIG. 3 or 4 and depicts the selected flooring at the location of the floor in the transformed image. The orientation of the depicted flooring can be changed by interacting with the graphical user interface (e.g., by interacting with the rotate surface 812 or remove product 813 controls). A user can select and drag moveable divider control 830 left or right in the image to reveal more or less of the updated transformed image (and correspondingly less or more of the transformed image). As may be appreciated, the features present (and locations of such features) can differ between an original image and a transformed image.

FIGS. 9A to 9C depicts an original image, a style conditioning prompt, and a transformed image generated using the method of FIG. 3 or 4, in accordance with disclosed embodiments. FIG. 9A depicts the original image. FIG. 9B depicts the style conditioning prompt. In this example, the style conditioning prompt is an image (e.g., provided by the user). FIG. 9C depicts the transformed image generated by the machine learning model based on the reference image and the style conditioning input. As can be seen from FIG. 9C, the transformed image can combine aspects of the two images (e.g., the general or approximate layout of the reference image and stylistic features of the style conditioning input).

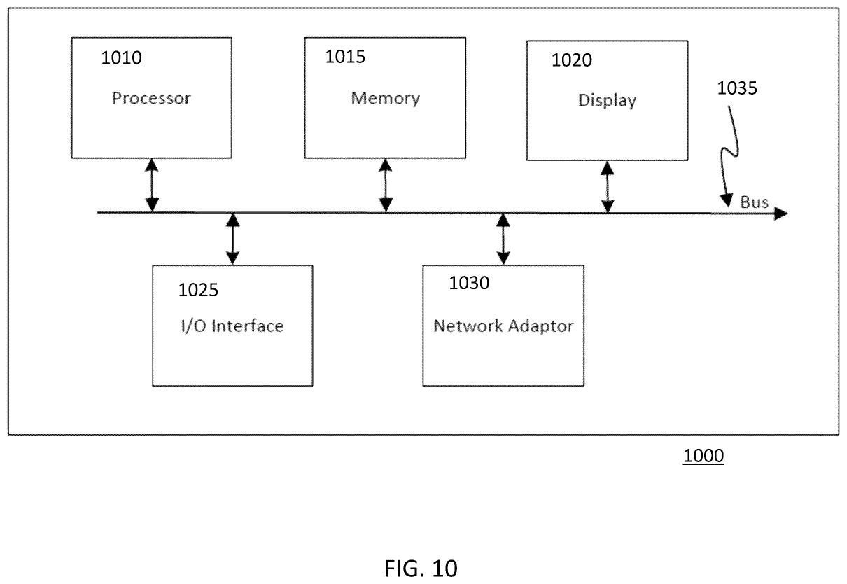

FIG. 10 depicts a schematic of exemplary computing system 1000 for performing the envisioned systems and methods, consistent with disclosed embodiments. In some embodiments, computing system 1000 can include a processor 1010, memory 1015, display 1020, I/O interface(s) 1025, and network adapter 1030. These units may communicate with each other via bus 1035, or wirelessly. The components shown in FIG. 10 may reside in a single device or multiple devices.

Consistent with disclosed embodiments, processor 1010 may comprise a central processing unit (CPU), graphical processing unit (GPU), or similar microprocessor having one or more processing cores. Computing system 1000 may include one or more processors 1010 and may further operate with one or more other processors that are remote with respect to processors 1010. Computing system 1000 may include one or more computer readable medium(s). Such a computer readable medium can be any tangible medium that can contain or store instructions for use by or in connection with computing system 1000 or another computing system or device. A computer readable medium can be a non-transitory computer-readable medium that stores, or is configured to store, data or instructions that cause a computing system 1000 or another computing system or device to operate in a specific fashion. Non-transitory media include, for example, optical or magnetic disks, dynamic memory, a floppy disk, a flexible disk, hard disk, solid state drive, magnetic tape, or any other non-transitory magnetic data storage medium, a CD-ROM, any other non-transitory optical data storage medium, any non-transitory physical medium with patterns of holes, a RAM, a PROM, and an EPROM, a FLASH-EPROM, NVRAM, flash memory, register, cache, any other memory chip or cartridge, and networked versions of the same. In some embodiments, computing system 1000 may include memory 1015. Memory 1015 may include a non-transitory memory containing non-transitory instructions, such as a computer hard disk, random access memory (RAM), removable storage, or remote computer storage. In some aspects, memory 1015 may be configured to store data and instructions, such as software programs. In some aspects, processor 1010 may be configured to execute non-transitory instructions and/or programs stored on memory 1015 to configure computing system 1000 to perform operations of the disclosed systems and methods.

Display 1020 may be any device which provides a visual output, for example, a computer monitor, an LCD screen, etc. I/O interface(s) 1025 may include hardware and/or a combination of hardware and software for communicating information to computing system 1000 from a user of computing system 1000, such as a keyboard, mouse, trackball, audio input device, touch screen, infrared input interface, or similar device. Network adapter 1030 may include hardware and/or a combination of hardware and software for enabling computing system 1000 to exchange information using external networks, such as network 160. For example, network adapter 1030 may include a wireless wide area network (WWAN) adapter, a Bluetooth module, a near field communication module, or a local area network (LAN) adapter.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system, comprising:
at least one processor; and
at least one non-transitory computer readable medium containing instructions that, when executed by the at least one processor, cause the system to perform operations for generating an image of a built environment, comprising:
providing, to a visualization application running on a client system, instructions to display in a first graphical user interface a style control;
receiving, from the visualization application, a selection of an original image of the built environment and a selection of the style control;
detecting a characteristic of the original image and enriching a style conditioning prompt based on the detected characteristic;
obtaining a transformed image generated by applying the original image and the style conditioning prompt to a generative artificial intelligence model;
identifying a segment in the transformed image associated with an architectural feature, furnishing, or object, in the transformed image using at least one machine-learning model;
providing, to the visualization application, instructions to display in the first graphical user interface the transformed image and a selectable graphical indicator of the identified segment;
receiving, from the visualization application, a selection a product and a selection of the selectable graphical indicator;
generating an updated transformed image that replaces the segment in the transformed image based on the selection of the product and the selection of the selectable graphical indicator; and
providing, to the visualization application, instructions to display in the first graphical user interface the updated transformed image.

2. The system of claim 1, wherein:
the style conditioning prompt comprises a textual prompt, the detected characteristic comprises a room type, an architectural feature, furnishing, or an object, and enriching the style conditioning prompt comprises modifying a textual prompt to indicate the room type, architectural feature, furnishing, or object.

3. The system of claim 1, wherein:
the style conditioning prompt comprises a textual, image, or auditory prompt.

4. The system of claim 1, wherein:
the architectural feature is a wall, floor, counter, staircase, ceiling, window, balcony, doorway, or door.

5. The system of claim 1, wherein:
identifying the segment in the transformed image comprises performing semantic segmentation of the transformed image or performing object detection in the transformed image.

6. A method for generating an image of a built environment, comprising:
obtaining, by an application system, an original image of the built environment and an enriched style conditioning prompt concerning a style of the built environment;
generating a transformed image by applying the original image and the enriched style conditioning prompt to a generative machine learning model;
identifying, by the application system, a segment in the transformed image associated with an architectural feature, furnishing, or object in the transformed image using at least one machine learning model;
generating, by the application system, an updated transformed image by replacing the segment in the transformed image; and
displaying, by a client system, the updated transformed image.

7. The method of claim 6, the method further comprising:
detecting a characteristic of the built environment using the original image; and
prior to generating the transformed image, generating the enriched style conditioning prompt using the detected characteristic of the built environment.

8. The method of claim 7, wherein:
the detected characteristic comprises a room type, architectural feature, furnishing, or object, and generating the enriched style conditioning prompt comprises modifying a textual prompt to indicate the room type, architectural feature, furnishing, or object.

9. The method of claim 7, wherein:
the enriched style conditioning prompt is further generated using a textual, image, or auditory prompt.

10. The method of claim 6, wherein:
the architectural feature is a wall, floor, counter, staircase, ceiling, window, balcony, doorway, or door.

11. The method of claim 6, wherein:
identifying the segment in the transformed image comprises performing semantic segmentation of the transformed image or object detection in the transformed image.

12. The method of claim 6, wherein:
the application system receives the original image from a visualization application running on the client system, or receives an identifier of the image from the visualization application.

13. The method of claim 6, wherein:
replacing the segment in the transformed image comprises depicting a user-selected product in the segment.

14. A system, comprising:
at least one processor; and
at least one non-transitory computer readable medium containing instructions that, when executed by the at least one processor, cause the system to perform operations for generating an image of a built environment, comprising:
obtaining an original image of the built environment and an enriched style conditioning prompt concerning a style of the built environment;
generating a transformed image by applying the original image and the enriched style conditioning prompt to a generative machine learning model;
identifying a segment in the transformed image associated with an architectural feature, furnishing, or object in the transformed image using at least one machine learning model;
generating an updated transformed image by replacing the segment in the transformed image; and
providing the updated transformed image for display on a client system.

15. The system of claim 14, the operations further comprising:
detecting a characteristic of the built environment using the original image; and
prior to generating the transformed image, generating the enriched style conditioning prompt using the detected characteristic of the built environment.

16. The system of claim 15, wherein:
the detected characteristic comprises a room type, architectural feature, furnishing, or object, and generating the enriched style conditioning prompt comprises modifying a textual prompt to indicate the room type, architectural feature, furnishing, or object.

17. The system of claim 14, wherein:
the enriched style conditioning prompt is further generated using a textual, image, or auditory prompt.

18. The system of claim 14, wherein:
the architectural feature is a wall, floor, counter, staircase, ceiling, window, balcony, doorway, or door.

19. The system of claim 14, wherein:
identifying the segment in the transformed image comprises performing semantic segmentation of the transformed image or object detection in the transformed image.

20. The system of claim 14, wherein:
the original image is received from a visualization application running on the client system, or an identifier of the image is received from the visualization application.
